(19) United States
(12) Patent Application Publication
(10) Pub. No.: US 2026/0311287 A1
(43) Pub. Date: Oct. 8, 2026

(54) STORING AND RETRIEVING RENDER OUTPUT

(71) Applicant: Arm Limited, Cambridge (GB)

(72) Inventors: Jakob Axel Fries, Lund (SE); Olof Henrik Uhrenholt, Lomma (SE)

(73) Assignee: Arm Limited, Cambridge (GB)

(21) Appl. No.: 19/629,692

(22) Filed: Mar. 26, 2026

(30) Foreign Application Priority Data
Apr. 3, 2025 (GB) 2505047.7

(51) Int. Cl. G06T 1/60; G06T 1/20

(52) U.S. Cl. CPC G06T 1/60; G06T 1/20

(57) ABSTRACT

A method at a graphics processing apparatus comprises producing 310, by graphics processing circuitry, an updated render output corresponding to at least a portion of a previous render output stored in storage as a data unit comprising header data and body data. The body data is stored in a first storage region. The header data comprises a reference to the first storage region. The method further comprises storing 312, by a storage control unit, at least a portion of the updated render output in the storage by: inspecting the reference to the first storage region in the header data of the data unit; selecting a storage region as a second storage region based on the reference to the first storage region; storing updated body data corresponding to the updated render output in the second storage region; and updating the header data in the storage such that the reference in the header data is a reference to the second storage region. The second storage region and the first storage region are different storage regions.

### FIELD

The present technology relates to graphics processing. In particular the present technology relates to producing render output, storing at least a portion of the render output in storage and retrieving at least a portion of the render output from the storage.

### BACKGROUND

Graphics processing is generally performed by first splitting a scene (e.g. a 3D model) to be displayed onto a number of similar basic components or “primitives”, which primitives are then subjected to the desired graphics processing operations. The graphics “primitives” are usually in the form of simple polygons, such as triangles. Once primitives and their vertices have been generated and defined, they can be further processed by a fragment processing pipeline, in order to generate the desired graphics processing output (render output), such as a frame for display. This usually involves determining which sampling points of an array of sampling points associated with the render output area to be processed are covered by a primitive, and then determining the appearance each sampling point should have (e.g. in terms of its colour) to represent the primitive at that sampling point. These processes are commonly referred to as rasterizing and rendering, respectively. The rendering process involves deriving the data, such as red, green and blue (RGB) colour values and an “alpha” (transparency) value, necessary to represent the primitive at the sampling points. Where necessary, newly generated data may be blended with data that has previously been generated for the sampling point in question.

In tile-based rendering, a render output is divided into a plurality of smaller regions, herein referred to as “tiles”. Each tile is rendered separately (typically one after another), and the rendered tiles are then recombined to provide the complete render output, e.g. a render pass or a frame to be displayed. A tile-based graphics processing pipeline includes one or more so-called tile buffers that store rendered fragment data at the end of the pipeline until a given tile is completed and written out to an external memory, such as a frame buffer, for use. In some tile-based graphics processing pipelines, the rendered fragment data is compressed before being written out to the external memory.

### SUMMARY

An aspect of the present technology provides a method and a graphics processing apparatus according to the appended claims.

According to an aspect of the present technology there is provided a method at a graphics processing apparatus comprising graphics processing circuitry, a storage control unit and storage, wherein the storage comprises a plurality of storage regions, the method comprising: producing, by the graphics processing circuitry, an updated render output, wherein the updated render output corresponds to at least a portion of a previous render output, and wherein the at least a portion of the previous render output is stored as a data unit in the storage, wherein the data unit comprises header data and body data, wherein the body data is stored in a first storage region of the plurality of storage regions and wherein the header data is stored in the storage and comprises a reference to the first storage region; and storing, by the storage control unit, at least a portion of the updated render output in the storage by: inspecting the reference to the first storage region in the header data of the data unit; selecting a storage region of the plurality of storage regions as a second storage region, wherein the second storage region is selected based on the reference to the first storage region in the header data and wherein the second storage region and the first storage region are different storage regions of the plurality of storage regions; storing updated body data corresponding to the updated render output in the second storage region; and updating the header data in the storage such that the reference in the header data is a reference to the second storage region.

According to an aspect of the present technology there is provided a graphics processing apparatus comprising graphics processing circuitry, a storage control unit and storage, wherein the storage comprises a plurality of storage regions, and wherein the graphics processing circuitry is configured to carry out a method comprising: producing, by the graphics processing circuitry, an updated render output, wherein the updated render output corresponds to at least a portion of an previous render output, and wherein at least a portion of the previous render output is stored as a data unit in the storage, wherein the data unit comprises header data and body data, wherein the body data is stored in a first storage region of the plurality of storage regions and the header data is stored in the storage, wherein the header data comprises a reference to the first storage region; and storing, by the storage control unit, at least a portion of the updated render output in the storage by: inspecting the reference to the first storage region in the header data of the data unit; selecting a storage region of the plurality of storage regions as a second storage region, wherein the second storage region is selected based on the reference to the first storage region in the header data and wherein the second storage region and the first storage region are different storage regions of the plurality of storage regions; storing updated body data corresponding to the updated render output in the second storage region; and updating the header data in the storage such that the reference in the header data is a reference to the second storage region.

Additional and/or alternative features, aspects and advantages of implementations of the present technology will become apparent from the following description, the accompanying drawings and the appended claims.

### BRIEF DESCRIPTION OF THE DRAWINGS

Embodiments will now be described, with reference to the accompanying drawings, in which:

FIG. 1 shows an exemplary graphics processing pipeline;

FIG. 2 shows an exemplary graphics processing system;

FIG. 3 shows an exemplary method at a graphics processing apparatus;

FIG. 4 shows a further exemplary method at a graphics processing apparatus; and

FIG. 5 shows an exemplary render output;

FIG. 6 shows an exemplary storage storing the exemplary render output of FIG. 5;

FIG. 7 shows an exemplary updated render output;

FIG. 8 shows the exemplary storage of FIG. 6 storing the exemplary updated render output of FIG. 7;

FIG. 9 shows an exemplary further updated render output;

FIG. 10 shows the exemplary storage of FIG. 6 storing the exemplary further updated render output of FIG. 9; and

FIG. 11 shows an exemplary method at a display controller.

### DETAILED DESCRIPTION

### Exemplary Embodiments

Optionally the method comprises: producing, by the graphics processing circuitry, the previous render output; and storing, by the storage control unit, at least a portion of the previous render output in the storage.

Optionally the data unit is a compressed data unit.

Optionally when the data unit is an uncompressed data unit the method comprises: suppressing, by the storage control unit, the selecting or updating steps such that the updated body data corresponding to the updated render output is stored in the same storage region as the body data corresponding to the previous render output.

Optionally the data Unit Comprises Image Data.

Optionally the data unit comprises image data corresponding to a region of a rendered image.

Optionally the region of the rendered image corresponds to a block of pixels or a tile.

Optionally the graphics processing apparatus is part of a data processing system comprising a display controller, and wherein the method further comprises: inspecting, by the display controller, header data of a current data unit in the storage; identifying, by the display controller, a storage region storing the body data of the current data unit based on a reference to a storage region in the header data; and retrieving, by the display controller, the body data of the current data unit from the identified storage region.

Optionally storing the data unit in the storage comprises: selecting, by the storage control unit, a storage region of the plurality of storage regions as a first storage region; storing, by the storage control unit, the body data of the data unit in the first storage region; and storing, by the storage control unit, the header data in the storage.

Optionally the method further comprises: producing, by the graphics processing circuitry, a further updated render output, wherein the further updated render output corresponds to at least a portion of the previous render output or a portion of the updated render output; and storing, by the storage control unit, at least a portion of the further updated render output in the storage by: selecting a storage region of the plurality of storage regions as a further storage region, wherein the further storage region is selected based on the reference to the second storage region in the header data and wherein the further storage region and the second storage region are different storage regions of the plurality of storage regions; storing further updated body data in the further storage region; and updating the header data in the storage such that the reference in the header data is a reference to the further storage region.

Optionally the further storage region is the first storage region.

Optionally the graphics processing apparatus is a tile-based graphics processing apparatus.

Optionally the graphics processing apparatus is part of a data processing system, and wherein the data processing system comprises a display controller configured to carry out a method comprising: inspecting, by the display controller, header data of a current data unit in the storage; determining, by the display controller, a storage region storing the body data of the current data unit based on a reference to a storage region in the header data; and retrieving, by the display controller, the body data of the current data unit from the storage region storing the body data of the current data unit.

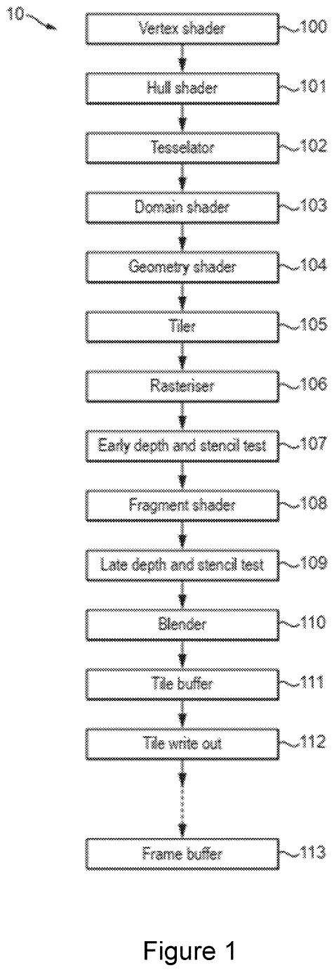

The present technology relates to tile-based graphics processing. The exemplary graphics processing pipeline 10 shown in FIG. 1 is a tile-based renderer that produces tiles of a render output data array, such as an output frame to be displayed.

FIG. 1 shows the main elements and pipeline stages of the graphics processing pipeline 10. As will be appreciated by those skilled in the art, there may be other elements of the graphics processing pipeline that are not shown in FIG. 1. It should be noted here that FIG. 1 is only schematic, and that, for example, in practice, the shown functional units and pipeline stages may share significant hardware circuits, even though they are shown functionally as separate states in FIG. 1. It will also be appreciated that each of the stages, elements and units, etc., of the graphics processing pipeline 10 may be implemented as desired and may accordingly comprise, e.g., appropriate circuitry and/or processing logic, etc., for performing the necessary operation and functions.

The graphics processing pipeline 10 includes a number of stages, including vertex shader 100, a hull shader 101 (in DirectX, or a Tessellation Control Shader in Vulkan or OpenGL), a tesselator 102, a domain shader 103 (in DirectX, or a Tessellation Evaluation Shader in Vulkan or OpenGL), a geometry shader 104, a tiler 105, a rasterization stage 106, an early Z (depth) and stencil test stage 107, a renderer in the form of a fragment shading state 108, a late Z (depth) and stencil test stage 109, a blending stage 110, a tile buffer 111, and a tile write out stage 112 that performs downsampling and writeout (multisample resolve).

The vertex shader 100 takes the input data values (vertex attribute values) associated with the vertices, etc., defined for the output to be generated, and processes those data values to generate a set of corresponding “vertex shaded” output data values for use by subsequent stages of the graphics processing pipeline.

For a given output to be generated by the graphics processing pipeline, there may typically be a set of vertices defined for the output in question. The primitives to be processed for the output may then be indicated as comprising given vertices in the set of vertices for the graphics processing output being generated.

The vertex shading operation operates to transform the attributes for each vertex into a desired form for the subsequent graphics processing operations. This may comprise, in particular, transforming vertex position attribute values from the model or object space for which they are initially defined to the screen space in which the output of the graphics processing system is to be displayed, modifying the input data to take account of the effect of lighting in the image to be rendered, etc.

The vertex shading operation may also convert the originally defined vertex position coordinates to a different, e.g. lower precision, form to be used later on in the graphics processing pipeline.

The hull shader 101 performs operations on sets of patch control points and generates additional data known as patch constants. The tessellation stage 102 subdivides geometry to create higher order representations of the hull, and the domain shader 103 performs operations on vertices output by the tessellation stage (similar to a vertex shader). The geometry shader 104 may (if run) generate primitives such as triangles, points or lines for processing.

Once all the primitives to be rendered have been appropriately processed, e.g. transformed, and/or, e.g. generated by the geometry shader, the tiler 105 then determines which primitives need to be processed for each tile into which the render output has been divided for processing purposes. To do so, the tiler 105 compares the location of each primitive to be processed with the tile positions, and adds the primitive to a respective primitive list for each tile within which it determines the primitive could (potentially) fall. Any suitable and desired technique for sorting and binning primitives into tile lists, such as exact binning, bounding box binning or anything in between, may be used for the tiling process.

Once the tiler 105 has completed the preparation of the primitive tile lists (lists of primitives to be processed for each tile), each tile is then rendered. To do so, each tile is processed by the graphics processing pipeline stages shown in FIG. 1 that follow the tiler 105. Thus, when a given tile is being processed, each primitive that is to be processed for that tile (that is listed in a tile list for that tile) is passed to the rasteriser 106.

The rasterization stage 106 of the graphics processing pipeline 10 operates to rasterise the primitives into individual graphics fragments for processing. In particular, the rasteriser 106, particularly a primitive set-up stage (otherwise known as a triangle set-up unit, TSU) of the rasteriser 106, operates to determine, from the vertex shaded vertices provided to the primitive set-up stage, edge information representing each primitive edge of a primitive to be rasterised. This edge information is then passed to a rasterization stage of the rasteriser 106, which rasterises the primitive to sampling points (e.g. pixels) and generates graphics fragments having appropriate positions (representing appropriate sampling positions) for rendering the primitive. It is possible for the primitive set-up stage to be separate from the rasteriser 106, e.g. at a stage of the graphics processing pipeline that is (e.g. immediately) before the rasteriser 106, but after the tiler 105.

The fragments generated by the rasteriser 106 are then sent onwards to the rest of the pipeline for processing.

The early Z/stencil stage 107 performs a Z (depth) test on fragments it receives from the rasteriser 106, to determine if any fragments can be discarded (culled) at this stage. In particular, the early Z/stencil stage 107 compares the depth values of (associated with) fragments issuing from the rasteriser 106 with the depth values of fragments that have already been rendered—these depth values are stored in a depth (Z) buffer that is part of the tile buffer 111—to determine whether the new fragments are occluded by fragments that have already been rendered (or not). At the same time, an early stencil test is also carried out.

Fragments that pass the fragment early Z and stencil test stage 107 are then sent to the fragment shading stage 108. The fragment shading stage 108 performs the appropriate fragment processing operations on the fragments that pass the early Z and stencil tests, so as to process the fragments to generate the appropriate rendered fragment data.

This fragment processing may include any suitable and desired fragment shading processes, such as executing fragment shader programs on the fragments, applying textures to the fragments, applying fogging or other operations to the fragments, etc., to generate the appropriate fragment data. In the present example, the fragment shading stage 108 is in the form of a shader pipeline (a programmable fragment shader).

There is then a late fragment Z and stencil test state 109, which carries out, amongst other things, an end of pipeline depth test on the shaded fragments to determine whether a rendered fragment can actually be seen in the final image. This depth test uses the Z-buffer value for the fragment's position stored in the Z buffer in the tile buffer 111 to determine whether the fragment data for the new fragments should replace the fragment data of the fragments that have already been rendered, by comparing the depth values of (associated with) fragments issuing from the fragment shading stage 108 with the depth values of fragments that have already been rendered (as stored in the depth buffer). This late fragment depth and stencil test stage 109 also performs any necessary late alpha and/or stencil tests on the fragments.

The fragments that pass the late fragment test stage 109 are then subjected to, if required, any necessary blending operations with fragments already stored in the tile buffer 111 in the blender 110. Any other remaining operations necessary on the fragments, such as dither, etc. (not shown) are also performed at this stage.

Finally, the (blended) output fragment data (values) are written to the tile buffer 111 from where they can e.g. be output to a frame buffer 113 for display. The depth value for an output fragment is also written appropriately to a Z buffer within the tile buffer 111. The tile buffer stores colour and depth buffers that store an appropriate colour, etc., or Z value, respectively, for each sampling point that the buffers represent (in essence for each sampling point of a tile that is being processed). These buffers store an array of fragment data that represents part (a tile) of the overall render output (e.g. image to be displayed), with respective sets of sample values in the buffers corresponding to respective pixels of the overall render output (e.g. each 2×2 set of sample values may correspond to an output pixel, where 4× multisampling is being used).

The tile buffer is provided as part of RAM that is located on (local to) the graphics processing pipeline (chip).

The data from the tile buffer 111 is input to a tile write out unit 112, and then output (written back) to an external memory output buffer, such as a frame buffer 113 of a display device (not shown). The display device may comprise, for example, a display comprising an array of pixels, such as a computer monitor or a printer.

The tile write out unit 112 downsamples the fragment data stored in the tile buffer 111 to the appropriate resolution for the output buffer (such that an array of pixel data corresponding to the pixels of the output device is generated) to generate output values (pixels) for output to the output buffer.

Once a tile of the render output has been processed and its data exported to a main memory (e.g. to a frame buffer 113 in a main memory) for storage, the next tile is then processed, and so on, until sufficient tiles have been processed to generate the entire render output (e.g. frame to be displayed). The process is then repeated for the next render output (e.g. frame) and so on. It should be noted that multiple tiles may be processed concurrently, for example each execution unit (e.g. shader core) may process a separate tile in parallel.

Other arrangements for a graphics processing pipeline are or course possible. The graphics processing pipeline 10 may be executed on and implemented by an appropriate graphics processing unit (GPU) that includes the necessary functional units, processing circuitry, etc., operable to execute the graphics processing pipeline stages.

In order to control a graphics processor (GPU) that is implementing a graphics processing pipeline to perform the desired graphics processing pipeline operations, the graphics processor typically receives commands and data from a driver, e.g. executing on a host processor (e.g. CPU), that indicates to the graphics processor the operations that it is to carry out and the data to be used for the operations.

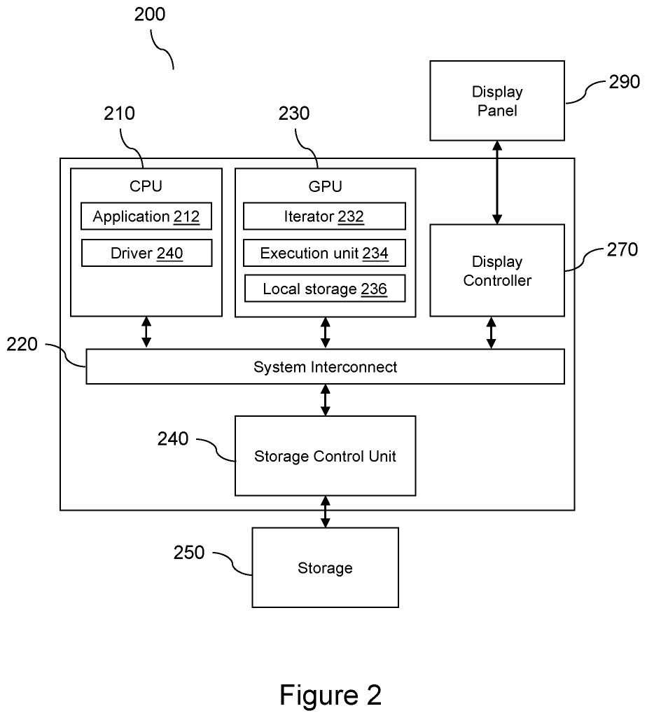

Accordingly, FIG. 2 shows schematically a typical computer graphics processing system 200, in which an application 212 such as a game executes on a host processor 210. When the application 212 requires graphics processing operations to be performed by an associated graphics processing unit (graphics processing pipeline) 230, it generates appropriate Application Programming Interface (API) calls that are interpreted by a driver 240 for the graphics processor 230 running on the host processor 210, to generate appropriate instructions (and data structures) for the graphics processor 230. The graphics processor 230 then generates graphics output required by the application 212 using the instructions (and data structures).

In particular, the graphics processor 230 comprises control circuitry (e.g. an iterator) 232, at least one (and in some examples more than one) execution unit 234 and a local storage 236 (e.g. tile buffer; where there is more than one execution unit, each execution unit preferably has its own associated local storage). A set of instructions is provided to the graphics processor 230 in response to instructions from the application 212/driver 240 running on the host system 210 for graphics output (e.g. to generate a frame to be displayed). For example, the driver 240 may send commands and data via system interconnect 220 to the graphics processor 230 by writing to storage 250. The control circuitry 232 breaks up the commands and data into one or more processing tasks, and assigns the tasks to the at least one execution unit 234, which processes the tasks in turn and outputs the processing results to the local storage 236. When a task completes, the processing output is written to storage 250 e.g. in compressed form. A storage control unit 240 can control the location in the storage 250 where the processing output is written.

Once a tile of a render output or frame has been processed and its data exported to storage 250 (e.g. to a frame buffer in storage 250), the next tile is then processed, and so on, until sufficient tiles have been processed to generate the entire render output (e.g. frame to be displayed). The process is then repeated for the next render output (e.g. frame) and so on. A frame (i.e. render output) may be displayed by the display panel 290 after the display controller 270 retrieves (and e.g. decompresses) the appropriate render output from the storage 250.

As will be appreciated, the display controller 270 cannot retrieve the render output from the storage 250 until the render output has been written to the storage 250 by the GPU 230. Problems may arise when the GPU 230 is writing a render output to the storage 250 at the same time as the display controller 270 retrieves the same render output from the same storage 250. In such situations, the display controller 270 may only be able to retrieve incomplete render output from the storage 250, leading to display errors.

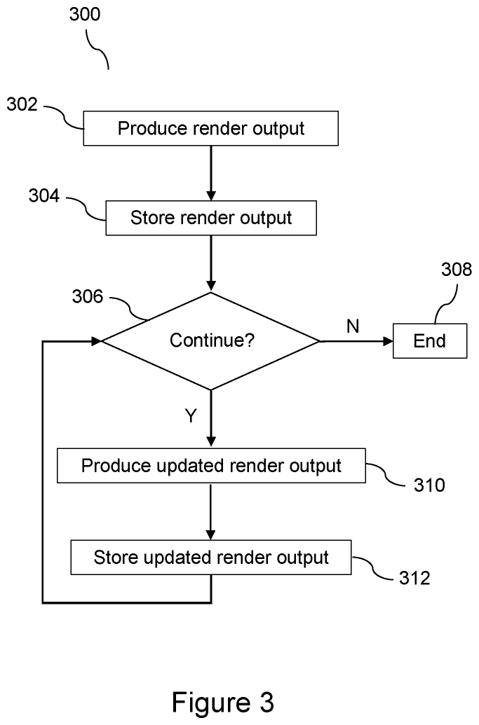

FIG. 3 shows a method 300 according to an example of the disclosure. The method 300 may be carried out at a graphics processing apparatus comprising graphics processing circuitry, a storage control unit and storage. In an example, the method 300 may be carried out at the tile-based graphics processing apparatus of FIG. 2 which comprises graphics processing circuitry (GPU 230), a storage control unit 240 and storage 250.

At step 302, the method 300 comprises producing a render output. The render output may be produced by the graphics processing circuitry, in particular the GPU 230, using the graphics processing pipeline 10. In examples, the render output comprises image data. In particular, the render output is e.g. a render pass or a frame to be displayed comprising a plurality of tiles, wherein each tile comprises a plurality of data units or blocks. Each data unit may correspond to a region of a rendered image, such as a block of pixels (e.g. a 16×16 block of pixels) or one or more tiles of the rendered image.

Each data unit comprises header data and body data. In particular examples explained below, each data unit comprises one header and two payloads. Each data unit may be a compressed data unit, or in some examples the data unit may be uncompressed.

At step 304, the method 300 comprises storing the render output in storage, for example in the storage 250 shown in FIG. 2. The storage used to store the render output produced in step 302 comprises a plurality of storage regions. The render output may be stored in the storage by a storage control unit, for example the storage control unit 240 shown in FIG. 2. The storage control unit is configured to control the location in the storage where the render output is stored. Once stored in the storage (e.g. in a frame buffer of the storage 250), the render output may be available to be retrieved from storage by a display or display controller, such as the display controller 270 of FIG. 2.

Storing the render output in the storage at step 304 may comprise selecting a storage region as a ‘first’ storage region which is then used to store the body data of each data unit of the render output. As noted above, the storage comprises a plurality of storage regions. For example, the storage 250 shown in FIG. 2 may comprise a plurality of frame buffers (e.g. first and second frame buffers) in which to store render output/frame data. As part of step 304, the storage control unit 240 may select one storage region (e.g. a first storage region or frame buffer) over another storage region (e.g. a second storage region or frame buffer) to store the body data of each data unit of the render output produced in step 302. Once the first storage region has been selected, the body data of each data unit of the render output is stored in that first storage region, and header data is also stored in the storage (e.g. storage 250). In examples, the header data of each data unit is saved in a header storage region in the storage (e.g. storage 250). As will be appreciated, the header data is typically much smaller in storage than the payload/body data.

As will be explained in further detail below, the header data is stored in the storage such that the header data includes a reference to the selected storage region in which the body data of each data unit of the render output is stored. The reference in the header data of each data unit may comprise a flag having a value which indicates the payload allocation for that data unit (e.g. having value 0 to indicate that the body/payload data is stored in the first storage region, or a value of 1 to indicate that the body/payload data is stored in the second storage region). In other examples, the reference in the header data may be a pointer to the storage region in which the corresponding body data is stored. The reference in the header data allows e.g. a display or display controller to locate and retrieve the body data from the storage by inspecting the header data. In examples, the header data also includes an indication of whether the body data is compressed or uncompressed. Such indication may be in the form of a flag (e.g. having value 0 for uncompressed body data and value 1 for compressed body data).

In addition to the reference to the selected storage region in which the body data of each data unit of the render output is stored, the header data may also comprise any suitable and desired information. In examples, the header data for an encoded block of data comprises one or more (e.g. all) of: information regarding the size of the encoded block (e.g. stored as the byte size of the compressed data), information regarding how the data in the block has been compressed, information regarding the size (e.g. stored as the byte size) of subdivisions of the compressed block (e.g. for video encoding formats where it may be possible to decode only part of the encoded block of data).

At step 306, the method 300 comprises deciding whether or not to continue with the method. For example, if the render output does not need to be updated (e.g. because no further frames or render passes are required), then the method 300 will proceed via the ‘N’ branch from step 306 to step 308 where the method 300 ends. Conversely, if the render output does need to be updated (e.g. because the application 212 requires further frames to be rendered by the GPU 230), then the method 300 continues by proceeding via the ‘Y’branch to step 310.

At step 310, the method 300 comprises producing, by the graphics processing circuitry, an updated render output. The updated render output (e.g. a new or partially updated frame) may also be produced by the graphics processing circuitry, in particular the GPU 230, using the graphics processing pipeline 10. In examples, the updated render output comprises image data. In particular, the updated render output is an updated frame comprising a plurality of tiles, wherein each tile comprises a plurality of data units or blocks. In examples, each data unit of the updated render output corresponds to a region of the previous render output (e.g. the render output produced in step 302, or a previous render output produced in step 310) and again corresponds to a region of a rendered image, such as a block of pixels (e.g. a 16×16 block of pixels) or a tile of the rendered image. Each data unit of the updated render output again comprises header data and body data and may be a compressed or uncompressed data unit.

At step 312, the method 300 comprises storing, by the storage control unit, at least a portion of the updated render output in the storage. The portion of the updated render output stored at step 312 may correspond to one or more data units that were produced previously (e.g. as part of the render output produced in step 302, or as part of a previous render output produced in step 310) and that are being updated at step 310.

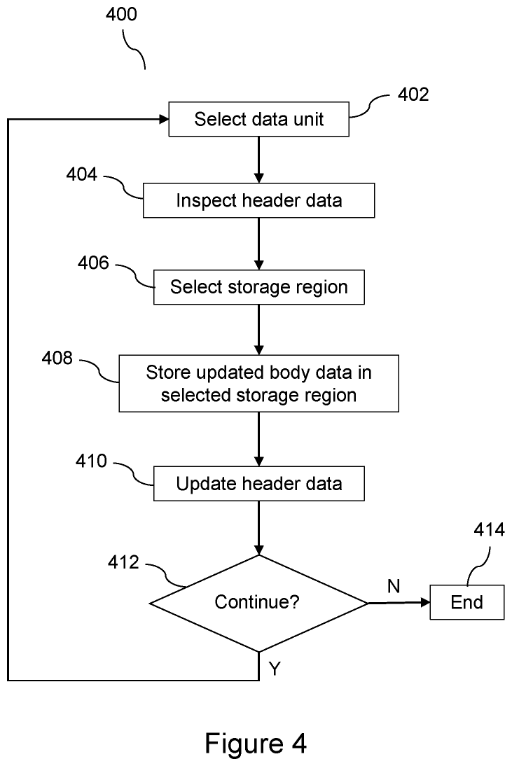

Step 312 may be implemented using method 400 shown in FIG. 4, which will now be described.

FIG. 4 shows a method of storing at least a portion of an updated render output in storage. The method 400 may be carried out at a graphics processing apparatus comprising graphics processing circuitry, a storage control unit and storage. In an example, the method 400 may be carried out at the tile-based graphics processing apparatus of FIG. 2 which comprises graphics processing circuitry (GPU 230), a storage control unit 240 and storage 250.

At step 402, the method 400 comprises selecting a data unit. In an example, the storage control unit may be configured to select a data unit of the updated render output that has been updated at step 310.

At step 404, the method 400 comprises inspecting the reference to the first storage region in the header data of the selected data unit. As noted above, during step 304 the render output produced in step 302 is stored by (i) storing the body data of each data unit of the render output in a selected first storage region, and (ii) storing the corresponding header data of each data unit in a header storage region. Since the header data of each data unit includes a reference to the selected storage region, the storage control unit (e.g. storage control unit 240) can identify the first storage region in which the body data of the selected data unit is stored by inspecting the reference to the first storage region in the corresponding header data.

In examples, the header data of each data unit also includes an indication of whether the body data is compressed or uncompressed, and this indication may also be inspected at step 404. Based on inspection of the header data at step 404, the storage control unit can determine from the header data whether or not the body data of the selected data unit is compressed.

At step 406, the method 400 comprises selecting a storage region of the plurality of storage regions as a second storage region. The second storage region is selected based on the reference to the first storage region in the header data inspected in step 404. In examples, the second storage region and the first storage region are different storage regions of the plurality of storage regions. For example, the second storage region and the first storage region may be different frame buffers in the storage 250. In other examples, the storage 250 may include more than two storage regions/frame buffers in which the body data of data units may be stored.

The second storage region is selected for storing a portion of the updated render output (in particular, the body data of the updated data units) in the storage. As will be explained in further detail below, selecting a second storage region which is different to the first storage region for a compressed data unit is beneficial since e.g. the graphics processing circuitry/storage control unit can write/store the body data of the updated data unit (produced in step 310) in the second storage region while e.g. a display controller reads the corresponding body data of a previous data unit (produced in step 302) from the first storage region.

The second storage region may be selected as a different storage region to the first storage region only in cases where the body data of a data unit is compressed. As noted above, storage control unit can determine at step 404 from an indication in the header data whether or not the body data of the selected data unit is compressed. In cases where the body data of a data unit is not compressed, the selection of a different storage region at step 406 may be suppressed. Suppression of the selection of the different storage region at step 406 may result in the previous storage region (i.e. the first storage region, in this example) being selected at step 406.

At step 408, the method 400 comprises storing the updated body data corresponding to the updated render output in the selected storage region. In examples, the storage control unit 240 stores the updated body data of the data unit in the second storage region of the storage 250 selected in step 406. As noted above, in cases where the body data of the data unit is compressed, the second storage region of the storage 250 is different to the first storage region.

At step 410, the method 400 comprises updating the header data in the header storage region. In particular, the header data for the data unit selected at step 402 is updated such that the reference in the header data is a reference to the selected storage region in which the updated body data for that data unit is stored. The reference in the header data may be updated by e.g. by updating an appropriate flag in the header data, by overwriting a pointer to the first storage region with a pointer to the second storage region, or by appending a pointer to the second storage region to the header data.

As noted above, in cases where the body data of a data unit is not compressed (for example, because the compression unit would be excessively noisy or has e.g. such a complex pixel pattern that the data does not compress to a smaller size), the selection of a different storage region at step 406 may be suppressed. Suppression of the selection of the different storage region at step 406 may result in the previous storage region (i.e. the first storage region) being selected at step 406. In such examples, the updating of the header data at step 410 may also be suppressed, since the reference to the storage region in which the updated body data is stored does not need to be changed/updated.

Once step 410 has completed, the method 400 proceeds to step 412, where a decision is made regarding whether or not to continue with the method 400. If the storage control unit does not need to store any further updated data units (e.g. if all updated data units produced at step 310 have been stored) then the method 400 will proceed via the ‘N’ branch from step 412 to step 414 where the method 400 will end and method 300 will resume at step 306. Conversely, if the storage control unit does need to store at least one further updated data unit (e.g. another block) then the method 400 will continue and proceed via the ‘Y’branch to step 402.

On returning to step 402, the storage control unit selects the next updated data unit, which may be another updated block. Steps 404-410 are repeated for this data unit. The method 400 continues until all updated data units of the updated render output have been stored. Method 300 resumes at step 306 once method 400 ends.

Once the updated render output is stored in the storage (e.g. in first and second frame buffers of the storage 250) and the header data of each updated data unit has been updated in step 410, the updated render output may be available to be retrieved from storage by e.g. a display controller such as the display controller 270 of FIG. 2.

During execution of the method 400, the storage control unit writes updated body data to the selected storage region before updating the reference in the header data, while a display controller can retrieve the data from storage by inspecting the header data for each data unit before retrieving the corresponding body data. This means that the display controller will not retrieve e.g. incomplete body data of an updated data unit from e.g. the second storage region while it is being written by the storage control unit. For compressed data, while the body data of an updated data unit is being written to the second storage region, the header data corresponding to that data unit points to the first storage region.

Returning to FIG. 3, once step 312 (and method 400) has completed, the method 300 returns to step 306, where a decision is made regarding whether or not to continue with the method 300. If the render output does not need to be updated again (or no longer needs to be updated), then the method 300 will proceed via the ‘N’ branch from step 306 to step 308 where the method 300 will end. Conversely, if the render output does need to be updated again (e.g. a further frame or renderpass is required), then the method 300 will continue and proceed via the ‘Y’ branch to step 310 where a further updated render output is produced, and step 312 where this further updated render output is stored using method 400, etc.

In the example explanation of methods 300 and 400 provided above, at step 304 the body data of a compressed data unit is stored in a first storage region, and at step 312 the body data of a corresponding updated data unit is stored in a second storage region. However, if at step 304 the body data of the compressed data unit were to be stored in the second storage region, then at step 312 the body data of a corresponding updated data unit would be stored in the first storage region.

In general, where a data unit having body data stored in the first storage region is to be updated, the body data of the updated data unit will be stored in the ‘other’ storage region (i.e. the second storage region). Conversely, where a data unit having body data stored in the second storage region is to be updated, the body data of the updated data unit will similarly be stored in the ‘other’ storage region (i.e. the first storage region). In other words, the methods 300, 400 are configured to ‘swap’ the storage locations of successive corresponding body data for compressed data units between the first and second storage regions.

While the present description is primarily focussed on cases where first and second storage regions are used to store body data (i.e. there are only two possible payload allocations), other numbers of storage regions (e.g. third, fourth, etc.) may be employed in other examples. The choice of two possible payload allocations constrains the size of the header in storage, for example.

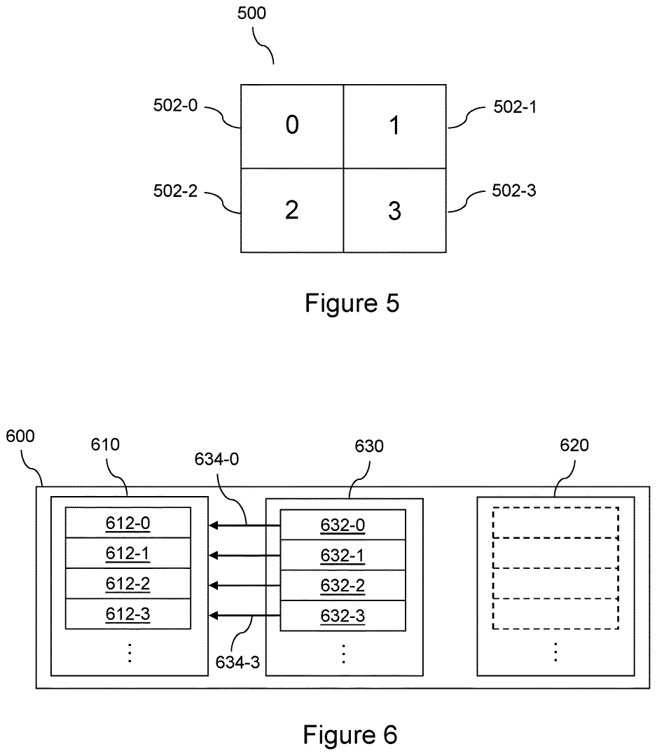

For illustrative purposes, the methods 300 and 400 shown in FIG. 3 and FIG. 4 will now be described with reference to the examples shown in FIG. 5 to FIG. 10.

FIG. 5 shows an example render output 500. The example render output 500 is an image (e.g. a first frame or renderpass) comprising four blocks 502-0, 502-1, 502-2 and 502-3. Each block 502 corresponds to a region of a rendered image, such as a block of pixels (e.g. a 16×16 block of pixels) or a tile of the rendered image. Each block of render output 500 comprises header data and body data. In this example, each block 502 of render output 500 is to be stored as a compressed data unit.

FIG. 6 shows an example storage 600 comprising a plurality of storage regions 610, 620 and 630. In the example of FIG. 6, the example render output 500 is stored in the storage 600. The example storage 600 may be the storage 250 shown in FIG. 2.

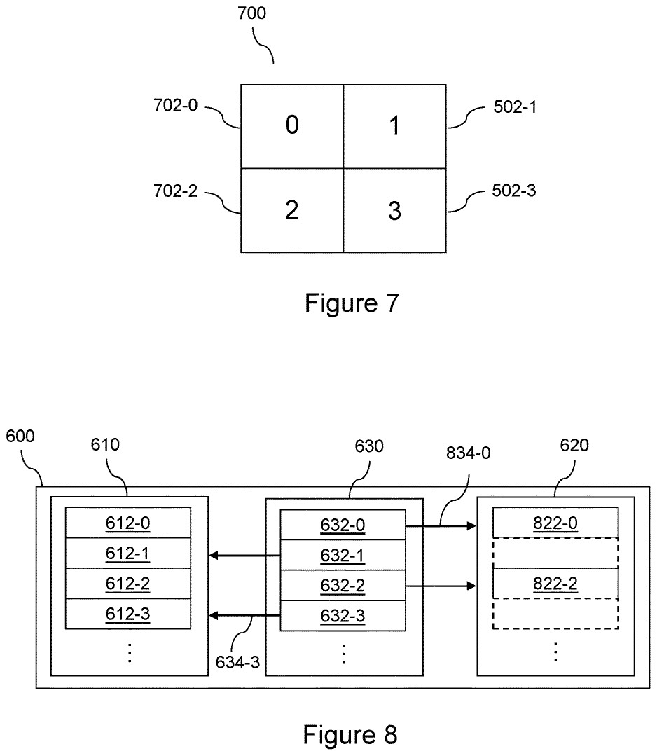

FIG. 7 shows an example updated render output 700. The example updated render output 700 is an image (e.g. a second frame or renderpass) comprising two non-updated blocks 502-1 and 502-3 (corresponding to blocks 502-1 and 502-3 of render output 500) and two updated blocks 702-0 and 702-2 (corresponding to blocks 502-0 and 502-2 of render output 500). Each block of updated render output 700 comprises header data and body data. In this example, each block of updated render output 700 is to be stored as a compressed data unit.

FIG. 8 again shows the example storage 600. In the example of FIG. 8, the example updated render output 700 is stored in the storage 600.

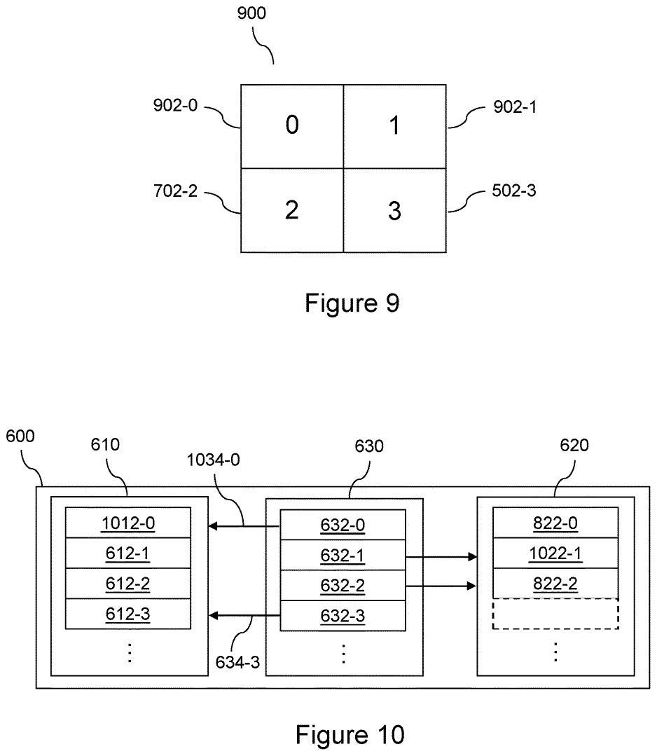

FIG. 9 shows an example of a further updated render output 900. The example further updated render output 900 is an image (e.g. a third frame or renderpass) comprising two non-updated blocks 502-3 and 702-2 (corresponding to blocks 502-3 and 702-2 of updated render output 700) and two updated blocks 902-0 and 902-1 (corresponding to blocks 702-0 and 502-1 of updated render output 700). Each block of further updated render output 900 comprises header data and body data. In this example, each block of further updated render output 900 is to be stored as a compressed data unit.

FIG. 10 again shows the example storage 600. In the example of FIG. 10, the example further updated render output 900 is stored in the storage 600.

In the present illustrative example, the method 300 begins at step 302 in which the render output 500 shown in FIG. 5 is produced. In this example, the render output 500 is produced by the GPU 230 using the graphics processing pipeline 10.

At step 304, the render output 500 is stored in storage. In this example, the render output 500 is stored in storage 600 shown in FIG. 6. Storage 600 comprises a plurality of storage regions, in particular a first storage region 610, a second storage region 620 and a header storage region 630. Storage control unit 240 selects the first storage region 610 to store the body data 612 of each block 502. The storage control unit 240 stores the header data 632 of each block 502 in the header storage region 630. The header data 632 of each block 502 includes a reference 634 (e.g. a pointer or flag) to the first storage region 610 in which the body data 612 of each block 502 is stored. For example, the header data 632-0 for the first block 502-0 includes a reference 634-0 to the first storage region 610 where the body data 612-0 for the first block 502-0 is stored.

Once the render output 500 is stored in the storage, the render output 500 is available to be retrieved from storage 600 by e.g. a display or display controller such as the display controller 270 of FIG. 2. To retrieve the render output 500 from the storage 600, the display or display controller must first inspect the header data of each data unit to determine the location of the corresponding body data.

In the present example, the render output 500 is to be updated (e.g. data for a next frame or renderpass) and the method 300 continues by proceeding via the ‘Y’ branch from step 306 to step 310.

At step 310, the updated render output 700 shown in FIG. 7 is produced. The example updated render output 700 includes two non-updated blocks 502-1 and 502-3 and two updated blocks 702-0 and 702-2. In this example, the updated render output 700 is produced by the GPU 230 using the graphics processing pipeline 10. In this example, the graphics processing circuitry produces the updated render output 700 by updating only blocks 502-0 and 502-2 of the previous render output 500. In other examples, the graphics processing circuitry could produce updated render output by updating more or fewer blocks.

At step 312, the method 300 comprises storing, by the storage control unit 240, at least a portion of the updated render output 700 in the storage 250. In particular, only the updated blocks 702-0 and 702-2 need to be stored/written in the storage 600, since the non-updated blocks 502-1 and 502-3 are already stored in the first storage region 610. The method 400 is used by the storage control unit 240 to store the updated blocks 702-0 and 702-2 of the updated render output 700 in the storage 600.

Starting with selecting updated block 702-0 at step 402, at step 404 the storage control unit 240 inspects the header data 632-0 corresponding to the updated block 702-0 (i.e. inspecting the header data 632-0 of block 502-0 of previous render output 500, which corresponds to the updated block 702-0 of updated render output 700). The storage control unit 240 retrieves the header data 632-0 from the header storage region 630 and inspects the reference 634-0 in the header data 632-0 corresponding to the updated block 702-0. In this example, the reference 634-0 is a reference to the first storage region 610.

At step 406, the storage control unit 240 selects the second storage region 620 for storing updated body data 822-0 corresponding to the updated block 702-0. The second storage region 620 is selected based on the reference 634-0 to the first storage region 610 in the header data 632-0 (and based on the data units comprising compressed data). The second storage region 620 is selected for the updated body data 822-0 since this is a different storage region to the first storage region 610 where the previous body data 612-0 is stored.

At step 408, the storage control unit 240 stores the updated body data 822-0 corresponding to the updated block 702-0 in the second storage region 620, since this is the storage region selected by the storage control unit 240 at step 406.

At step 410, the header data 632-0 corresponding to the updated block 702-0 is updated. In particular, the header data 632-0 in the header storage region 630 is updated by the storage control unit 240 such that the reference in the header data 632-0 is a reference 834-0 to the second storage region 620.

In the present example, method 400 initially continues at step 412 and steps 402-410 are repeated for the other updated block 702-2 of updated render output 700.

Once step 312 is completed for the other updated block 702-2 the updated render output 700 is fully stored in the storage 600. In particular, the body data of blocks 502-1 and 502-3 are stored in the first storage region 610, the body data of blocks 702-0 and 702-2 are stored in the second storage region 620 and the header data of each block 502-1, 502-3, 702-0 and 702-2 is stored in the header storage region 630. The headers 632 in the header storage region 630 include appropriate references (e.g. 634-3, 834-0) to the storage region 610, 620 in which corresponding body data is stored.

Once the updated render output 700 is stored in the storage, the updated render output 700 is available to be retrieved from storage 600 by e.g. a display or display controller such as the display controller 270 of FIG. 2. To retrieve the updated render output 700 from the storage 600, the display or display controller must first inspect the header data of each data unit to determine the location of the corresponding body data.

In the present example, the updated render output 700 is to be updated again and the method 300 continues by proceeding via the ‘Y’ branch from step 306 to step 310.

At step 310, the further updated render output 900 shown in FIG. 9 is produced. The further updated render output 900 may be produced by graphics processing circuitry, in particular the GPU 230, using the graphics processing pipeline 10. In this example, the graphics processing circuitry produces the further updated render output 900 by updating only blocks 502-1 and 702-0 of the previous render output 700. In other examples, the graphics processing circuitry could produce the further updated render output by updating more or fewer blocks.

At step 312, the method 300 comprises storing, by the storage control unit 240, at least a portion of the further updated render output 900 in the storage 250. In particular, only the updated blocks 902-0 and 902-1 need to be stored/written in the storage 600, since the body data of each of the non-updated blocks 502-3 and 702-2 is already stored in the first and second storage regions 610, 620, respectively.

The method 400 is used by the storage control unit 240 to store the updated blocks 902-0 and 902-1 of the further updated render output 900 in the storage 600.

Starting with selecting updated block 902-0, at step 404 the storage control unit 240 inspects the current header data 632-0 corresponding to the updated block 902-0 (i.e. inspecting the header data 632-0 of block 702-0 of previous render output 700, which corresponds to the updated block 902-0 of updated render output 900). The storage control unit 240 retrieves the header data 632-0 from the header storage region 630 and inspects the reference 834-0 in the header data 632-0 corresponding to the updated block 902-0. In this example, the reference 834-0 is a reference to the second storage region 620.

At step 406, the storage control unit 240 selects the first storage region 610 for storing updated body data 1022-0 corresponding to the updated block 902-0. The first storage region 610 is selected based on the reference 834-0 to the second storage region 620 in the header data 632-0 (and based on the data units comprising compressed data). The first storage region 610 is selected for the further updated body data 1022-0 since this is a different storage region to the second storage region 620 where the previous body data 822-0 is stored.

At step 408, the storage control unit 240 stores the updated body data 1022-0 corresponding to the updated block 902-0 in the first storage region 610, since this is the storage region selected by the storage control unit 240 at step 406.

At step 410, the header data 632-0 corresponding to the updated block 902-0 is updated. In particular, the header data 632-0 in the header storage region 630 is updated by the storage control unit 240 such that the reference in the header data 632-0 is a reference 1034-0 to the first storage region 610.

In the present example, method 400 initially continues at step 412 and steps 402-410 are repeated for the other updated block and steps 402-410 of the method 400 are repeated for the other updated block 902-1 of further updated render output 900.

Once step 312 is completed the updated render output 900 is fully stored in the storage 600. In particular, the body data 612-3, 1012-0 of blocks 502-3 and 902-0 are stored in the first storage region 610, the body data 822-2, 1022-1 of blocks 702-2 and 902-1 are stored in the second storage region 620 and the header data of each block 502-3, 702-2, 902-0 and 902-1 is stored in the header storage region 630. The headers 632 in the header storage region 630 include appropriate references (e.g. 634-3, 1034-0) to the storage region 610, 620 in which corresponding body data is stored.

Once the further updated render output 900 is stored in the storage, the further updated render output 900 is available to be retrieved from storage 600 by e.g. a display or display controller such as the display controller 270 of FIG. 2. To retrieve the further updated render output 900 from the storage 600, the display or display controller must first inspect the header data of each data unit to determine the location of the corresponding body data.

In the present example, only three render outputs (frames) are produced and once step 312 for the last updated block of further updated render output 900 is completed the method 300 returns to step 306 and proceeds via the ‘N’ branch to step 308 where the method 300 ends. However, in other examples more or fewer render outputs (frames or renderpasses) may be processed. As will be appreciated, the render outputs 500, 700 and 900 may include different numbers of blocks, for example more or fewer blocks. Each block may correspond to a single tile or multiple tiles, or all blocks may correspond to one tile.

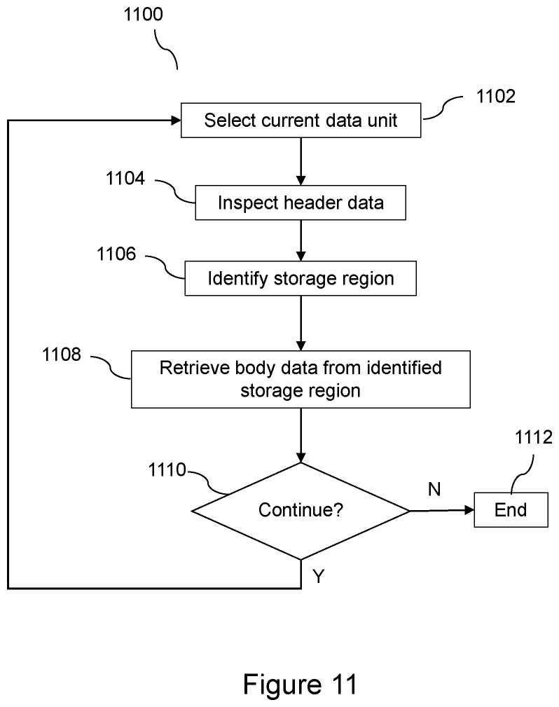

FIG. 11 shows a method 1100 according to an example of the disclosure. The method 1100 may be carried out at a display controller, such as the display controller 270 of FIG. 2. Advantageously, the method 1100 allows the display controller to access render output in storage (e.g. storage 250, 600).

At step 1102, the method 1100 comprises selecting a current data unit. In an example, the display controller may be configured to retrieve from memory image data that is to be rendered at a display. The current data unit may correspond to a block or tile for that to-be-rendered image. In examples, the current data unit corresponds to a data unit stored in steps 304 or 312 of method 300.

At step 1104, the method 1100 comprises inspecting, by the display controller, header data of the current data unit in the storage. In particular, the display controller may search the header storage region of the storage for the header data corresponding to the current data unit. Once the header data has been identified, the display controller may inspect a reference to a storage region in the header data. The reference to the storage region in the header data allows the display controller to determine the location of the corresponding body data for the current data unit.

At step 1106, the method 1100 comprises identifying a storage region. In particular, the display controller identifies the storage region storing the body data of the current data unit based on the reference to the storage region in the corresponding header data.

At step 1108, the method 1100 comprises retrieving body data from the identified storage region. In particular, the display controller retrieves the body data of the current data unit from the storage region identified using the reference in the header data of the current data unit. Once retrieved by the display controller, the body data of the current may be stored in e.g. a local cache and/or sent directly to a display, such as the display panel 290 shown in FIG. 2. The display controller may also retrieve the header data of the current data unit for storage in e.g. the local cache or for being sent directly to a display.

Once step 1108 has completed, the method 1100 proceeds to step 1110, where a decision is made regarding whether or not to continue with the method 1100. If the display controller does not need to retrieve any further data units (e.g. another block of the same render output/frame or of a different render output/frame) then the method 1100 will proceed via the ‘N’ branch from step 1110 to step 1112 where the method 1100 ends. Conversely, if display controller does need to retrieve a further data unit (e.g. another block) then the method 1100 will continue and proceed via the ‘Y’ branch to step 1102.

On returning to step 1102, the display controller selects the next data unit as the current data unit. In such cases, the current data unit may be another block of a tile or an updated block and steps 1104-1110 are repeated for this data unit. The method 1100 continues until all data units have been retrieved.

For illustrative purposes, the method 1100 shown in FIG. 11 will now be described with reference to the examples shown in FIG. 5 to FIG. 10.

In this illustrative example, the render outputs 500, 700 and 900 are to be rendered by e.g. the display panel 290 shown in FIG. 2, and the corresponding data in memory 250, 600 is accessed by the display controller 270. As will be understood from the following discussion, certain steps of the method 1100 may be carried out concurrently with certain steps of methods 300, 400 (i.e. while the render outputs 500, 700 and 900 are being produced/stored) so that the display controller accesses data in the memory after that data has been written or updated by the storage control unit 240. In other words, the methods 300 and 1100 may be executed simultaneously.

The method 1100 begins at step 1102 in which the display controller 270 selects the first block 502-0 of the example render output 500 as a current data unit. Step 1102 cannot begin until at least step 304 has completed.

At step 1104, the display controller inspects the header data 632-0 of the current data unit (first block 502-0), which is stored in the header storage region 630 of the storage 600. The reference 634-0 to the first storage region 610 in the header data 632-0 allows the display controller to determine the location of the body data 612-0 for the first block 502-0 as the first storage region 610.

At step 1106, the display controller identifies the first storage region 610 as the region of storage 600 storing the body data 612-0 of the first block 502-0 based on the reference 634-0 in the header data 632-0.

At step 1108, the display controller retrieves the body data 612-0 of the first block 502-0 from the first storage region 610.

Once steps 1102-1108 of method 1100 are completed for the first block 502-0, the display controller repeats these steps for the second, third and fourth blocks 502-1, 502-2 and 502-3 of the example render output 500 (i.e. each time 1110 is reached the ‘Y’ branch is followed).

Once steps 1102-1108 of method 1100 have been repeated for each of the blocks 502 of the example render output 500, the display controller proceeds to the updated render output 700. In some examples, steps 1102-1108 are repeated for each of the blocks of the updated render output 700.

For the updated render output 700, the method 1100 returns to step 1102 in which the display controller 270 selects the first block 702-0 of the updated render output 700 as the current data unit. As will be appreciated, the updated blocks 702-0 and 702-2 of the updated render output 700 cannot be selected/retrieved from storage until they have been stored and the corresponding header data has been appropriately updated by the storage control unit 240. In other words, step 1102 cannot begin for any of the updated blocks of updated render output 700 until at least step 312 has completed for the updated render output 700.

At step 1104, the display controller inspects the header data 632-0 of the current data unit (first block 702-0), which is stored in the header storage region 630 of the storage 600. The reference 834-0 to the second storage region 620 in the header data 632-0 allows the display controller to determine the location of the updated body data 822-0 for the first block 702-0 as the second storage region 620.

At step 1106, the display controller identifies the second storage region 620 as the region of storage 600 storing the body data 822-0 of the first block 702-0 based on the reference 834-0 in the updated header data 632-0.

At step 1108, the display controller retrieves the body data 822-0 of the first block 702-0 from the second storage region 620.

Once steps 1102-1108 of method 1100 are completed for the first block 702-0, the display controller repeats these steps for at least the other updated block 702-2 of the updated render output 700 (i.e. each time 1110 is reached the ‘Y’branch is followed).

Once steps 1102-1108 of method 1100 have been repeated for each of the blocks of the updated render output 700, the display controller proceeds to the further updated render output 900. In some examples, steps 1102-1108 are repeated for each of the blocks of the further updated render output 900.

For the further updated render output 900, the method 1100 returns to step 1102 in which the display controller 270 selects the first block 902-0 of the further updated render output 900 as the current data unit. As will be appreciated, the updated blocks 902-0 and 902-1 of the further updated render output 900 cannot be selected/retrieved from storage until they have been stored and the corresponding header data has been appropriately updated by the storage control unit 240. In other words, step 1102 cannot begin for any of the updated blocks of further updated render output 900 until at least step 312 has completed for the further updated render output 900.

At step 1104, the display controller inspects the header data 632-0 of the current data unit (first block 902-0), which is stored in the header storage region 630 of the storage 600. The reference 1034-0 to the first storage region 610 in the header data 632-0 allows the display controller to determine the location of the updated body data 1012-0 for the first block 902-0 as the first storage region 610.

At step 1106, the display controller identifies the first storage region 610 as the region of storage 600 storing the body data 1012-0 of the first block 902-0 based on the reference 1034-0 in the updated header data 632-0.

At step 1108, the display controller retrieves the body data 1012-0 of the first block 902-0 from the first storage region 610.

Once steps 1102-1108 of method 1100 are completed for the first block 902-0, the display controller repeats these steps for at least the other updated block 902-1 of the updated render output 700 (i.e. each time 1110 is reached the ‘Y’ branch is followed). As will be appreciated, for further updated render output 900, body data for some blocks is stored in the first storage region 610, body data for other blocks is stored in the second storage region 620 and each reference 634 points to the appropriate storage region 610, 620.

Once steps 1102-1108 of the method 1100 have been repeated for each of the blocks of the further updated render output 900, the ‘N’ branch from step 1110 is followed and the method ends. As will be appreciated, the method 1100 is repeated until all frames/blocks have been rendered.

As will be appreciated by one skilled in the art, the present techniques may be embodied as a system, method or computer program product. Accordingly, the present techniques may take the form of an entirely hardware embodiment, an entirely software embodiment, or an embodiment combining software and hardware.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object-oriented programming languages and conventional procedural programming languages.

For example, program code for carrying out operations of the present techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as VerilogTM or VHDL (Very high-speed integrated circuit Hardware Description Language).

The program code may execute entirely on the user's computer, partly on the user's computer and partly on a remote computer or entirely on the remote computer or server. In the latter scenario, the remote computer may be connected to the user's computer through any type of network. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

It will also be clear to one of skill in the art that all or part of a logical method according to the preferred embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

The examples and conditional language recited herein are intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its scope as defined by the appended claims.

Furthermore, as an aid to understanding, the above description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to limit the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labelled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

It will be clear to one skilled in the art that many improvements and modifications can be made to the foregoing exemplary embodiments without departing from the scope of the present techniques.

1. A method at a graphics processing apparatus comprising graphics processing circuitry, a storage control unit and storage, wherein the storage comprises a plurality of storage regions, the method comprising:
producing, by the graphics processing circuitry, an updated render output, wherein the updated render output corresponds to at least a portion of a previous render output, and wherein the at least a portion of the previous render output is stored as a data unit in the storage, wherein the data unit comprises header data and body data, wherein the body data is stored in a first storage region of the plurality of storage regions and wherein the header data is stored in the storage and comprises a reference to the first storage region; and
storing, by the storage control unit, at least a portion of the updated render output in the storage by:
inspecting the reference to the first storage region in the header data of the data unit;
selecting a storage region of the plurality of storage regions as a second storage region, wherein the second storage region is selected based on the reference to the first storage region in the header data and wherein the second storage region and the first storage region are different storage regions of the plurality of storage regions;
storing updated body data corresponding to the updated render output in the second storage region; and
updating the header data in the storage such that the reference in the header data is a reference to the second storage region.

2. The method of claim 1, wherein the method comprises:
producing, by the graphics processing circuitry, the previous render output; and
storing, by the storage control unit, at least a portion of the previous render output in the storage.

3. The method of claim 1, wherein the data unit is a compressed data unit.

4. The method of claim 1, wherein when the data unit is an uncompressed data unit the method comprises:
suppressing, by the storage control unit, the selecting or updating steps such that the updated body data corresponding to the updated render output is stored in the same storage region as the body data corresponding to the previous render output.

5. The method of claim 1, wherein the data unit comprises image data.

6. The method of claim 1, wherein the data unit comprises image data corresponding to a region of a rendered image.

7. The method of claim 6, wherein the region of the rendered image corresponds to a block of pixels or a tile.

8. The method of claim 1, wherein the graphics processing apparatus is part of a data processing system comprising a display controller, and wherein the method further comprises:
inspecting, by the display controller, header data of a current data unit in the storage;
identifying, by the display controller, a storage region storing the body data of the current data unit based on a reference to a storage region in the header data; and
retrieving, by the display controller, the body data of the current data unit from the identified storage region.

9. The method of claim 1, wherein storing the data unit in the storage comprises:
selecting, by the storage control unit, a storage region of the plurality of storage regions as a first storage region;
storing, by the storage control unit, the body data of the data unit in the first storage region; and
storing, by the storage control unit, the header data in the storage.

10. The method of claim 1, wherein the method further comprises:
producing, by the graphics processing circuitry, a further updated render output, wherein the further updated render output corresponds to at least a portion of the previous render output or a portion of the updated render output; and
storing, by the storage control unit, at least a portion of the further updated render output in the storage by:
selecting a storage region of the plurality of storage regions as a further storage region, wherein the further storage region is selected based on the reference to the second storage region in the header data and wherein the further storage region and the second storage region are different storage regions of the plurality of storage regions;
storing further updated body data in the further storage region; and
updating the header data in the storage such that the reference in the header data is a reference to the further storage region.

11. The method of claim 10, wherein the further storage region is the first storage region.

12. A graphics processing apparatus comprising graphics processing circuitry, a storage control unit and storage, wherein the storage comprises a plurality of storage regions, and wherein the graphics processing circuitry is configured to carry out a method comprising:
producing, by the graphics processing circuitry, an updated render output, wherein the updated render output corresponds to at least a portion of an previous render output, and wherein at least a portion of the previous render output is stored as a data unit in the storage, wherein the data unit comprises header data and body data, wherein the body data is stored in a first storage region of the plurality of storage regions and the header data is stored in the storage, wherein the header data comprises a reference to the first storage region; and
storing, by the storage control unit, at least a portion of the updated render output in the storage by:
inspecting the reference to the first storage region in the header data of the data unit;
selecting a storage region of the plurality of storage regions as a second storage region, wherein the second storage region is selected based on the reference to the first storage region in the header data and wherein the second storage region and the first storage region are different storage regions of the plurality of storage regions;
storing updated body data corresponding to the updated render output in the second storage region; and
updating the header data in the storage such that the reference in the header data is a reference to the second storage region.

13. The graphics processing apparatus of claim 12, wherein the graphics processing apparatus is a tile-based graphics processing apparatus.

14. The graphics processing apparatus of claim 12, wherein the graphics processing apparatus is part of a data processing system, and wherein the data processing system comprises a display controller configured to carry out a method comprising:
inspecting, by the display controller, header data of a current data unit in the storage;
determining, by the display controller, a storage region storing the body data of the current data unit based on a reference to a storage region in the header data; and
retrieving, by the display controller, the body data of the current data unit from the storage region storing the body data of the current data unit.
